(19) United States
(12) Patent Application Publication
(10) Pub. No.: US 2021/0141162 A1
(43) Pub. Date: May 13, 2021

(54) FIBER OPTIC CONNECTOR HAVING EFFICIENT CONSTRUCTION

(71) Applicant: Senko Advanced Components, Inc., Marlborough, MA (US)

(72) Inventors: Siu Kei MA, Kowloon (HK); Man Ming HO, Kowloon (HK); Man Kit Joe WONG, Kowloon (HK)

(73) Assignee: Senko Advanced Components, Inc., Marlborough, MA (US)

(21) Appl. No.: 17/094,549

(22) Filed: Nov. 10, 2020

Related U.S. Application Data
(60) Provisional application No. 62/933,729, filed on Nov. 11, 2019.

(51) Int. Cl. G02B 6/38

(52) U.S. Cl. CPC G02B 6/387; G02B 6/3893; G02B 6/381

(57) ABSTRACT

A fiber optic connector has a housing including separately formed housing portions configured to be connected to each other to cooperatively define an enclosure. A first of the housing portions has a latch formed integrally with the first housing portion. A fiber optic ferrule is located in the enclosure of the housing. The housing portions each define a back post element which together define a back post of the housing configured for securing a cable to the housing.

### CROSS-REFERENCE TO RELATED APPLICATION

This application claims priority to U.S. Provisional App. No. 62/933,729, filed Nov. 11, 2019, the entirety of which is hereby incorporated by reference.

### FIELD

The present disclosure generally relates to fiber optic connections, and, more specifically, to a fiber optic connector having an efficient construction.

### BACKGROUND

Optical connectors are used within optical communication networks to interconnect optical cables to optical devices or other optical cables. Optical connections typically involve two optical connectors connected together. Typically, the connectors are constructed of many parts, which increases both component cost and manufacturing cost.

### SUMMARY

In one aspect of the present invention, a fiber optic connector generally comprises a housing including separately formed housing portions configured to be connected to each other to cooperatively define an enclosure. A first of the housing portions has a latch formed integrally with the first housing portion. A fiber optic ferrule is located in the enclosure of the housing.

In another aspect of the present invention, a fiber optic connector generally comprises a housing including first and second housing portions. The first and second housing portions each includes a front body element and a back post element, and are configured to be connected to each other so that front body elements cooperate to define a front body, and the back post elements cooperate to define a back post shaped and arranged for mounting a cable on the back post. A fiber optic ferrule is located in the front body of the housing.

Other objects and features of the present disclosure will be in part apparent and in part pointed out hereinafter.

### BRIEF DESCRIPTION OF THE DRAWINGS

FIG. 1 is a perspective of a duplex LC fiber optic connector according to one embodiment of the present disclosure;

FIG. 2 is an exploded perspective of the fiber optic connector;

FIG. 3 is an exploded elevation of a housing, ferrule and spring of the fiber optic connector;

FIG. 4 is an elevation of the assembled fiber optic connector housing, ferrule and spring;

FIG. 5 is an exploded perspective of a duplex LC fiber optic connector according to another embodiment of the present disclosure including a back post reinforcement tube;

FIG. 6 is an exploded perspective of a housing, ferrules, springs and the reinforcing tube of the fiber optic connector of FIG. 5;

FIG. 7 is a fragmentary perspective of the assembled components of FIG. 6, with parts of the housing broken away so reveal the reinforcing tube;

FIG. 8 is a fragmentary, schematic longitudinal section through the assembled fiber optic connector of FIG. 5;

FIG. 9 is a perspective of a fiber optic connector housing including a reinforcing tube exploded from the housing of yet another embodiment of the present disclosure;

FIG. 10 is a fragmentary perspective of the assembled housing and reinforcing tube of FIG. 9 with parts of the housing broken away; and

FIG. 11 is a fragmentary, schematic longitudinal section of a fiber optic connector including the housing and reinforcing tube of FIG. 9.

Corresponding reference characters indicate corresponding parts throughout the drawings.

### DETAILED DESCRIPTION

Referring to FIGS. 1-4, a fiber optic connector is generally indicated at reference numeral 10. The fiber optic connector 10 is used to form a fiber optic connection with a fiber optic receptacle (not shown). The illustrated embodiments all show a duplex, LC uniboot optical connector, but other connector forms could be used within the scope of the present disclosure. As used herein, a fiber optic receptacle can be any device that connects to a fiber optic connector, including a fiber optic receptacle, a fiber optic adapter (e.g., an LC duplex style adapter) and a fiber optic connector. When the fiber optic receptacle and the fiber optic connector assembly 10 are coupled together, an optical connection (e.g., a fiber optic connection) is formed that enables communication (e.g., optical communication) between different fiber optic components (e.g., cables, devices, etc.) in an optical communications network. The fiber optic connector 10 is attached to an end of a fiber optic cable (not shown in FIGS. 1-4) to couple the cable to the fiber optic receptacle, although other arrangements are within the scope of the present disclosure. Still other configurations of the fiber optic connector assembly 10 are within the scope of the present disclosure. For example, the connector assembly could make electrical or other types of connections instead of or in addition to an optical connection.

The fiber optic connector 10 includes a housing 12 substantially enclosing (first and second) fiber optic ferrules 14 that project through an open front end of the housing. The housing includes a body 16 and a back post 18 (see, FIG. 4). A crimp ring 20 is received on the back post 18, and a strain relief boot 22 is attached to the housing 12. A latch 24 formed integrally with the housing includes arms 26 extending upward and rearward from a front end of the housing. The latch arms 26 are resilient so that when deflected upon insertion of the fiber optic connector 12 into a fiber optic receptacle, the arms 26 bend down toward the body 16 through engagement with the receptacle. However, when nubs 28 on the arms 26 come into alignment with corresponding recesses (not shown) on the fiber optic receptacle, the arms resiliently snap upward to lodge the nubs in the recesses to hold the fiber optic connector 10 in connection with the fiber optic receptacle. A release pad 30 connected to both arms 26 can be depressed to move the nubs 28 out of the recesses to permit removal of the fiber optic connector 12 from the fiber optic receptacle.

The housing 12 is made up of separately formed upper (broadly, “first”) housing portion 34 and lower (broadly, “second”) housing portion 36. In the illustrated embodiments, the upper and lower housing portions 34, 36 are molded (e.g., from a polymeric material) as separate pieces that are connected together to form the finished housing 12. As connected together, the upper and lower housing portions 34, 36 define an enclosure 38 that contains the ferrules 14 and associated springs 40, and receives optical fibers from the cable (not shown) that are connected to the ferrules. The distal ends of the ferrules 14 project out of the enclosure 38. The body 16 includes plug frames 42 (broadly, “a front body”) projecting forward from a back body 44. The upper housing portion 34 includes plug frame elements 46 (broadly, “a front body element” or “plug portion”) and a back body element 48, and the lower housing portion 36 includes corresponding plug frame elements 50 (broadly, “a front body element”) and a back body element 52. As shown, the plug fame elements 50 and back body element 52 of the lower housing portion 36 define most of the volume of the enclosure 38, although other arrangements are possible. The upper housing portion 34 can be connected to the lower housing portion 36. To that end, the lower housing portion 36 is formed with openings 54 on both sides of each of the plug frame elements 50, and the upper housing portion 34 is formed with corresponding tabs 56 on the plug frame elements 46 that snap into the openings (e.g., see FIG. 4). Further, the back body element 48 of the upper housing portion 34 is formed with a depending connecting finger 58 on each side of the back body element 52 of the lower housing portion 36 (only one connecting finger may be seen in FIGS. 1-4). Free ends of the connecting fingers 58 are biased into recesses 60 formed in the back body element 52. Other and/or additional features to connect the upper housing portion 34 and lower housing portion 36 together may be used. It is also envisioned that more than two components (i.e., upper housing portion 34 and lower housing portion 36) may be used to form the housing 12, or more particularly to define the enclosure 38.

The back post 18 is formed when a back post element 62 of the upper housing portion 34 comes together with a back post element 64 of the lower housing portion 36 to form the tubular back post. As best shown in FIGS. 3 and 4, each of the back post elements 62, 64 is a semi-cylinder forming about one half of the back post 18, although other shapes and proportions are possible. The back post elements 62, 64 are each formed with a multiplicity of ribs 66, extending circumferentially of the back post 18. The ribs 66 define a non-smooth surface on the back post 18. Thus, when the crimp ring 20 is deformed against strength fibers (not shown in FIGS. 1-4) of the cable, the non-smooth surface of the back post 18 formed by the ribs 66 facilitates gripping the strength fibers so that the mechanical connection of the cable to the fiber optic connector 10 is constituted by the connection of the strength fibers to the back post 18. Other structures and methods for augmenting the grip of the strength fibers by the back post 18 and/or crimp tube 20 may be used within the scope of the present disclosure.

The upper housing portion 34, including its component plug frame elements 46, latch 24, back body element 50 and back post element 62, are molded as one piece of material. Likewise, the lower housing portion 36, including its component plug frame elements 50, back body element 52 and back post element 64 are molded as one piece of material. The components could be formed separately and made integral with each other, however, there is an advantage to keeping the number of components to a minimum. Regarding the latch 24 and particularly the latch arms 26, they merge with the material of the plug frame elements 46 near a front end of the plug frame elements. The intersection forms a living hinge for the arms 26. From the point of intersection to the release pad 30, the arms 26 extend rearward and outward away from the plug frame elements 46 of the upper housing portion 34.

Referring now to FIGS. 5-8, a fiber optic connector of a second embodiment is designated generally at 110. Except as described hereinafter, the fiber optic connector 110 has the same construction and operation as the fiber optic connector 10 of the first embodiment. Parts of the fiber optic connector 110 will be given the same reference numerals as the corresponding parts of the fiber optic connector 10, plus “100”. The fiber optic connector 110 includes a reinforcing tube 170 that is received in the back post 118 of the connector. As shown, the reinforcing tube 170 is formed separately from the housing 112 of a suitably strong material such as metal. The reinforcing tube 170 and back post elements 162, 164 are sized and shaped so that the reinforcing tube can be received between the semi-cylindrical back post elements so that the back post elements circumferentially enclose the reinforcing tube. FIG. 7 shows a fragment of the connector housing 112 with the reinforcing tube 170 received in the back post 118. As shown in FIG. 8, a cable 172 including strength fibers 174 is received in an end of the crimp tube 120. FIG. 8 is a schematic illustration and so the construction of the cable is simplified, including by removing the optical fibers. The strength fibers 174 lie between the crimp tube 120 and the ribs 166 of the back post 118. The force applied to the crimp tube 120 is not only resisted by the back post 118, but also by the reinforcing tube 170 which helps to maintain the structural integrity of the back post.

Referring now to FIGS. 9-11, a fiber optic connector 210 is shown. The construction and operation of the fiber optic connector is closely similar to that of the fiber optic connector 10 of the first embodiment, and the fiber optic connector 110 of the second embodiment, except as described hereinafter. Accordingly, parts of the fiber optic connector 210 will be referenced by the same reference numerals as the corresponding parts of the fiber optic connector 10, plus “200” and by the same reference numerals as the corresponding part of the fiber optic connector 110, plus “100.” The back post 218 of the fiber optic connector 210 has a smaller diameter than the back posts 18, 118 of the first two embodiments. Moreover, the back post 218 does not have ribs, but instead has a generally smooth surface. The reinforcing tube 270 fits over rather than within the back post 218, as may be seen in FIG. 10. As shown in FIG. 11, when the cable 272 is received in the crimp tube 220, strength fibers 274 lie between the crimp tube and the reinforcing tube 270 (rather than between the crimp tube 120 and the back post 118 as in the second embodiment). Although not illustrated, the crimp tube 220 or the reinforcing tube 270 could be formed with an irregular or rough outer surface to facilitate gripping of the strength fibers. Straight pull performance of optical connectors including reinforcing tubes 170, 270 is increased.

Modifications and variations of the disclosed embodiments are possible without departing from the scope of the invention defined in the appended claims. For example, where specific dimensions are given, it will be understood that they are exemplary only and other dimensions are possible. Use of directional terms like “upper” and “lower” are for convenience and do not require any particular orientation of the parts described.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A fiber optic connector comprising:
a housing including separately formed housing portions configured to be connected to each other to cooperatively define an enclosure, a first of the housing portions having a latch formed integrally with the first housing portion;
a fiber optic ferrule located in the enclosure of the housing.

2. The fiber optic connector of claim 1 wherein the latch is formed as one piece of material with the first housing portion.

3. The fiber optic connector of claim 2 wherein the latch is joined with the first housing portion adjacent a forward end of the housing at a joining location and extends rearward from the jointing location to a free end spaced from the first housing portion, the latch further comprising a release pad spaced rearward from the joining location and configured to be depressed for releasing a connection of the latch.

4. The fiber optic connector of claim 1 wherein the first housing portion includes a body element and a back post element, and a second of the housing portions includes a body element and a back post element.

5. The fiber optic connector of claim 4 wherein the back post element of the first housing portion and the back post element of the second housing portion are configured for mounting a fiber optic cable thereon.

6. The fiber optic connector of claim 5 further comprising a reinforcing tube engaged with the tubular back post for reinforcing the tubular back post.

7. The fiber optic connector of claim 6 further comprising a crimp ring mounted on the back post and a boot attached to the housing.

8. The fiber optic connector of claim 5 wherein the body elements of the first and second housing portions cooperatively define a body containing the fiber optic ferrule.

9. The fiber optic connector of claim 8 wherein the fiber optic ferrule constitutes a first fiber optic ferrule, the fiber optic connector further comprising a second fiber optic ferrule contained in the body, and a spring for each the first and second fiber optic ferrules, the springs being located in the body and engaging respective ones of the first and second fiber optic ferrules.

10. A fiber optic connector comprising:
a housing including first and second housing portions, the first and second housing portions each including a front body element and a back post element, the first and second housing portions being configured to be connected to each other so that front body elements cooperate to define a front body, and the back post elements cooperate to define a back post shaped and arranged for mounting a cable on the back post;
a fiber optic ferrule located in the front body of the housing.

11. The fiber optic connector of claim 10 wherein each of the first and second housing portions is a unitary molded piece of material.

12. The fiber optic connector of claim 11 wherein each of the back post elements includes ribs.

13. The fiber optic connector of claim 11 further comprising a reinforcing tube engaged with the back post for reinforcing the back post.

14. The fiber optic connector of claim 10 wherein the reinforcing tube is received within the back post.

15. The fiber optic connector of claim 13 further comprising a crimp ring mounted on the back post and a boot attached to the housing.

16. The fiber optic connector of claim 15 in combination with the cable, the cable including reinforcing strands engaging the ribs of the back post elements and being compressed against the ribs by the crimp ring to secure the cable to the housing, the cable further comprising an optical fiber extending through the back post into the body and connected to the fiber optic ferrule.

17. The fiber optic connector of claim 10 wherein the fiber optic ferrule constitutes a first fiber optic ferrule, the fiber optic connector further comprising a second fiber optic ferrule contained in the body, and a spring for each fiber optic ferrule, the springs being located in the body and engaging respective ones of the first and second fiber optic ferrules.

18. An LC uniboot duplex fiber optic connector comprising:
a housing including first and second housing portions, the first and second housing portions each including a front body element configured for plugging into a fiber optic receptacle, a back body element and a back post element, the first and second housing portions being configured to be connected to each other so that front body elements cooperate to define a front body, the back body elements cooperate to define a back body, and the back post elements cooperate to define a back post shaped and arranged for mounting a cable on the back post;
first and second fiber optic ferrules located in the front body of the housing.

19. The LC uniboot duplex fiber optic connector as set forth in claim 18 further comprising a latch on the first housing portion.

20. The LC uniboot duplex fiber optic connector as set forth in claim 19 wherein the latch is formed as one piece of material with the first housing portion.

21. The LC uniboot duplex fiber optic connector as set forth in claim 18 wherein the latch comprises an LC latch configured to connect to an LC duplex adapter.
